(19) United States
(12) Patent Application Publication
(10) Pub. No.: US 2008/0214108 A1
(43) Pub. Date: Sep. 4, 2008

(54) Contactless Communications Method Based On Asynchronous Modulations And Demodulations

(75) Inventors: Edith Beigne, Meaudre (FR); Damien Caucheteux, Grenoble (FR); Elisabeth Crochon, Poisat (FR); Marc Renaudin, Biviers (FR)

Correspondence Address: OBLON, SPIVAK, MCCLELLAND MAIER & NEUSTADT, P.C., 1940 DUKE STREET, ALEXANDRIA, VA, 22314, US

(73) Assignees: COMMISSARIAT A L'ENERGIE ATOMIQUE, Paris (FR); CENTRAL NATIONAL DE LA RECHERCHE SCIENTIFIQUE, Paris (FR); INSTITUT NATIONAL POLYTECHNIQUE DE GRENOBLE, Grenoble (FR)

(21) Appl. No.: 11/910,621

(22) PCT Filed: Apr. 10, 2006
(86) PCT No.: PCT/FR2006/050320

§ 371 Date: Oct. 4, 2007

(30) Foreign Application Priority Data
Apr. 12, 2005 (FR) 05 50937

(51) Int. Cl. H04B 5/00

(52) U.S. Cl. 455/41.1

(57) ABSTRACT

The invention relates to a method for exchanging information by inductive coupling or without contact between a reader (2) and a transponder (4), comprising a number of demodulation steps, by the transponder, of a transmission signal coming from the reader, each demodulation step being associated with: a detection of a jump of a parameter of the transmission signal, of a first state to a second state among a set of stable states that the parameter of the transmission signal is capable of adopting; a comparison of the magnitude of the jump and/or of the direction of the jump, at one or more predetermined threshold values; an association with the magnitude of the jump and/or with the direction of the jump, at a value independent of the first state, and; a detection of a stabilization at the second state before another demodulation. The invention also relates to a device for carrying out said method.

### TECHNICAL FIELD AND PRIOR ART

This invention relates to contactless or wireless communicating systems and in particular radiofrequency identification (RFID) techniques, performing data exchanges between a stationary station or “reader”, and a transponder, such as, for example, a card or a ticket or a tag, placed in the electromagnetic field emitted by the reader.

The communications take place inductively between the reader and the transponder when the latter enters the coupling area of the station. The invention relates in particular to an asynchronous method for transferring information or data between a reader and a transponder, implementing modulation steps, for example by the reader, called “event-related”, which are mutually asynchronous and asynchronous with the carrier signal, and demodulation steps, for example in the transponder, also called “event-related”, which are mutually asynchronous and asynchronous with a carrier signal or with the modulated carrier signal.

As shown in FIG. 1, a reader 2 exchanges magnetic radiofrequency signals with a transponder 4. These signals comprise information or data, and can also be exploited by the transponder, so as to enable it to create its supply voltage. These signals can also comprise clock data, or synchronization data, so as to enable the transponder to determine the rate at which the data or information is transmitted.

Conventionally, the reader sends its information to the transponder by amplitude modulation ASK (ASK for Amplitude Shift Keying). To increase the rate of information exchanged between the stationary station and the transponder, it is then possible either to increase the frequency of the modulating signal or to increase the number of modulation amplitude levels.

The documents “Bidirectional High Data Transmission Interface for Inductively Powered devices”, Gervais J F. et al., IEEE Canadian Conference on Electrical and Computer Engineering, vol. 1, pages: 167-170, May 2003 and “High Power Efficiency Inductive Link with Full-Duplex Data Communication”, Hu Y. et al., 9th International Conference on Electronics, Circuits and Systems, vol. 1, pages: 359-362, September 2002, propose a method for transferring data from the reader to the tag, using another type of modulation, in particular a BPSK-type phase modulation (BPSK for “Binary Phase Shift Keying”).

This type of method implements synchronous modulation steps using a NRZ code (NRZ for “non-return to zero”), after which the data is transmitted at a constant rate by the reader. To demodulate the carrier signal transmitted by the reader, the transponder regularly samples the signal phase position, using, for example, rate information contained in this carrier signal.

The documents [1]: “A new contactless smart card IC using an on-chip antenna and an asynchronous microcontroller”, Abrial A. et al., IEEE Journal of Solid-State Circuits, vol. 36, n° 7, pages: 1101-1107, 2001, [2]: “Applying asynchronous circuits in contactless smart cards”, Kessels J et al., In Froc. International Symposium on Advanced Research in Asynchronous Circuits and Systems, pages: 36-44, IEEE Computer Society Press, April 2000, and [3]: “A contactless smartcard designed with asynchronous circuit technique”, Pui Lam Sui. et al, In Froc. European Solid-State Circuits Conference (ESSCIRC), 2003, describe RFID devices comprising a transponder implemented in an asynchronous logic circuit. In these asynchronous logic devices, the communications between the transponder and the reader are, however, performed synchronously by means of a protocol defined by the standard 14443. The information exchanges between the reader and the transponder are performed according to the rate set by this standard and are constant over the course of an exchange between the transponder and the reader.

Document [4]: Caucheteux D., “Communication par lien inductif pour étiquettes RFID asynchrones, Proceedings des VII^{èmes} Journées Nationales du Réseau des Doctorants en Microélectronique” [Inductive link communication for asynchronous RFID tags, Proceedings of the 7th National Days of the Network of Doctoral Candidates in Microelectronics], Marseille, May 2004, proposes a method for implementing synchronous information exchanges between the reader and the transponder according to a variable rate.

This variable rate is implemented by means of a communication protocol authorizing frames of distinct length, wherein the length of the frames is controlled by the reader-transponder device.

The problem is raised of finding a new method for transferring information or data by inductive coupling or without contact between a reader and a transponder, in which the rate of information transmitted can be controlled dynamically.

### DESCRIPTION OF THE INVENTION

The invention relates to a method for transferring information or data by inductive coupling or without contact between a reader and a transponder, in which a new type of demodulation, as well as a new type of demodulation, are implemented.

The invention relates in particular to a method for asynchronous exchange of information by inductive coupling or without contact between a reader and a transponder, comprising:
a plurality of steps of demodulation, by the transponder, of a “transmission” signal coming from the reader, wherein each demodulation step is associated with:

a) a detection of a transmission signal parameter jump, from a first state to a second state, among a set of stable states that the parameter of the transmission signal is capable of adopting,

b) a comparison of the amplitude of the jump and/or the direction of the jump, with one or more predetermined threshold values,

c) an association of the amplitude of the jump and/or the direction of the jump, with a value, independent of the first state,

d) a detection of a stabilization at the second state, prior to another demodulation.

Step a) includes a comparison of the transmission signal with a reference signal. This reference signal can be an internal signal, for example generated by demodulation means of the transponder.

According to an alternative, this reference signal can be dependent on the value of the parameter at the first state and the value of the transmission signal, preceding said first state.

According to an alternative, the reference signal can be controlled by the parameter, for example by the phase, of the transmission signal.

The demodulation can possibly be followed, in addition, after step c) and before another demodulation: by a step of sending, to the reader, a demodulation acknowledgement signal.

According to a possibility, the method according to the invention can implement exchanges by means of a handshake protocol.

According to an example, said parameter is the transmission signal phase. Alternatively, it can also be the frequency or the amplitude of this signal.

According to an implementation possibility, the method for exchanging information by inductive coupling or without contact according to the invention can also comprise: a plurality of steps of modulation, by the reader, of a modulating signal using at least one carrier signal, wherein the modulations are mutually asynchronous and asynchronous with the carrier signal.

According to an alternative of the method, a selection is made, prior to said modulations, of at least one carrier and an initial state of a parameter of the carrier among a plurality of states that the parameter of the carrier is capable of adopting, wherein the modulations can also be associated respectively with:
a detection of at least one new data item to be modulated,
a selection of a new state, among a plurality of states that the parameter of the carrier is capable of adopting, according to a previously selected state, and of the value of said new data item.

This method makes it possible to confer, on the communications between the reader and the transponder, an increased flexibility, and can make it possible to implement data exchanges between the reader and the transponder according to at least one first rate and at least one second rate, different from the first rate, as well as a passage from the first rate to the second rate or from the second rate to the first rate, over the course of these exchanges. The first rate can be, for example, a so-called “slow” rate, for which the consumption of the transponder and/or reader is limited, whereas the second rate can be, for example, a so-called “fast” rate, for which the exchange rate between the transponder and the reader is maximized.

The method also enables an automatic adaptation to a change in rate of information over the course of an exchange, as well as a very high compatibility with certain asynchronous digital circuits of the transponder, for example with a microcontroller that is almost insensitive to delays.

According to the invention, the transponder can operate according to a principle of constant detection of events on the carrier. Thus, this method also implements an automatic data standby by the transponder.

The periodicity of the jumps is irregular and non-correlated with the carrier signal. At the level of the demodulation performed by the transponder, each jump can be received and recognized independently of its predecessor and its successor. The demodulation can be performed without a transmit or reference clock of the rate, to the transponder. The transponder is capable of performing a demodulation of the information reaching it without knowing the times of arrival between transients. The rate can then be variable. The rate of the transmission is therefore dynamically adjustable in a data transfer.

The invention also relates to a transponder device or a device for reading information by inductive coupling or without contact, comprising:
means for receiving a so-called “transmission” signal,
means for implementing a plurality of steps for demodulation of a “transmission” signal, and, for each demodulation step:
detecting a transmission signal parameter jump from a first state to a second state,

comparing the amplitude of the jump and/or the direction of the jump, with one or more predetermined threshold values,
associating the amplitude of the jump and/or the direction of the jump with a value, independent of the first stable state,
detecting a stabilization at the second state, prior to another demodulation.
According to a possible implementation of the transponder device, the means for detecting a jump of a parameter of the transmission signal from a first state to a second state include means for comparing the transmission signal with a reference signal.

According to an alternative, the reference signal can be dependent on the value of a parameter at the first state and the value of the parameter of the transmission signal.

The device can optionally also comprise: means for sending, after a demodulation and prior to another demodulation, a demodulation acknowledgement signal.

Said parameter can be, for example, the phase of the transmission signal.

The invention also relates to a device for reading by inductive coupling or without contact, comprising:
means for forming a so-called “transmission” signal, based on at last one carrier signal,
means for transmitting the “transmission” signal,
means for implementing a plurality of steps of modulation of the “transmission” signal, by a modulating signal, wherein the modulations are mutually asynchronous and asynchronous with the carrier signal.

According to an alternative embodiment of this device, in which the means for implementing a plurality of “transmission” signal modulation steps also include means for acquisition of a modulating signal comprising a plurality of data to be modulated, the means for implementing a plurality of modulation steps can also include:
means for selecting, prior to said modulations, an initial state of a parameter of the carrier signal among a plurality of states that the parameter of the carrier signal is capable of adopting, and for selecting, at each of said modulations, a new state of the parameter of the carrier, according to a previously selected state and the modulating signal.

### BRIEF DESCRIPTION OF THE DRAWINGS

This invention can be better understood on reading the following description of example embodiments provided purely for indicative and non-limiting purposes, in reference to the appended drawings, in which:

FIG. 1 shows a contactless reader-transponder system,

FIGS. 2A-2D show signals implemented in a modulation method according to the invention,

FIG. 3 shows a coding implemented in a modulation method according to the invention,

FIG. 4 shows a modulation device according to the invention,

FIG. 5 shows a phase locked loop of a demodulation device according to the invention,

FIG. 6 shows a process of detecting a phase deviation between two signals,

FIG. 7 shows an asynchronous device for detecting phase jumps of a demodulation device according to the invention,

FIG. 8 shows a method for processing a modulated carrier signal, implemented by a demodulation device according to the invention.

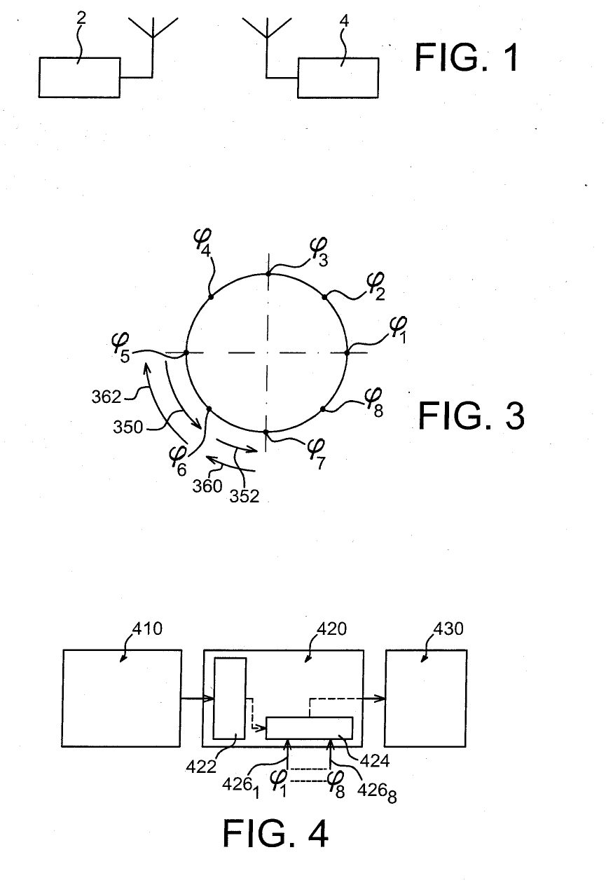

Identical, similar or equivalent parts of the various figures have the same numeric references for the sake of consistency between figures.

The various parts shown in the figures are not necessarily shown according to a uniform scale, so as to make the figures easier to read.

### DETAILED DESCRIPTION OF SPECIFIC EMBODIMENTS

An example of a modulation device according to the invention, integrated in the reader 2, is shown in FIG. 4, and implements modulation steps, for example for phase modulation of a carrier signal by a modulating signal, wherein the modulations are mutually asynchronous and asynchronous with the carrier signal.

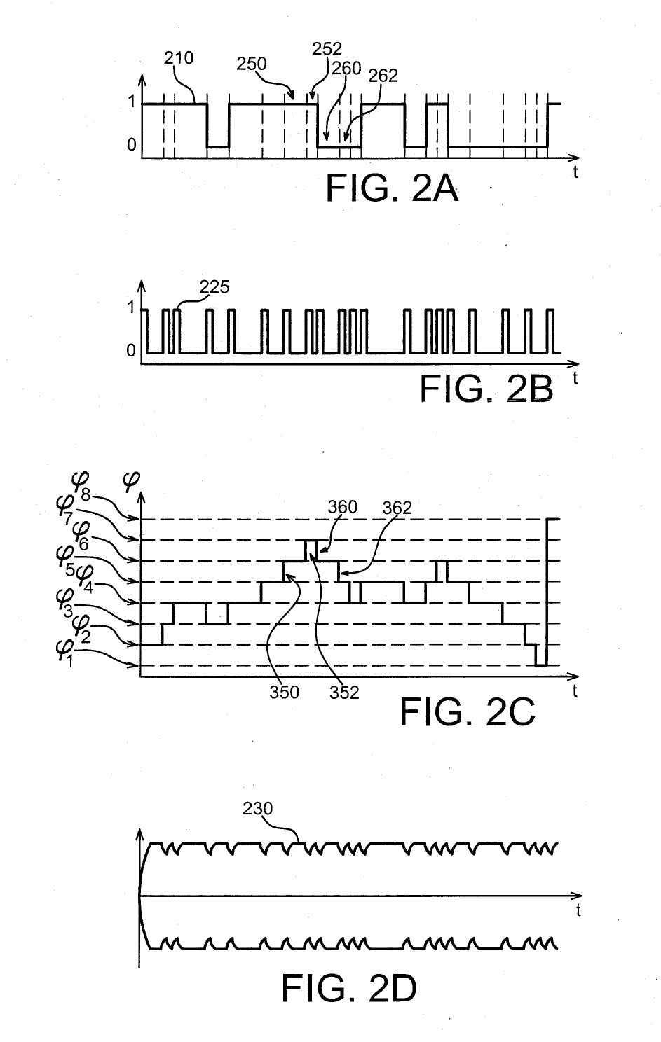

The modulating signal comes from a stage or an asynchronous circuit 410, such as, for example, a microcontroller, and comprises a succession of information or data items to be transmitted, which can be transmitted at an irregular rate by the asynchronous circuit 410, to a modulation stage 420 of the reader. The arrival of new data is indicated to the stage 420 by a local synchronization signal, such as that referenced 225 shown in FIG. 2B, coming from the circuit 410.

The modulation stage 420 includes in particular multiplexing means 424 comprising, for example, k=8 inputs 426₁, . . . ,426₈, as well as a state machine 422, capable of selecting, upon receiving a new data item to be modulated, an input among the 426₁, . . . , 426₈, of the multiplexing means 424. The inputs 426₁, . . . ,426₈ of the multiplexing means 424 are connected or associated with means (not shown) capable of delivering a carrier, of which a parameter, for example the phase, is at a given stable state among a set or a list of, for example, k=8 stable states. Each input 426₁, . . . ,426₈ is associated with a carrier and a stable state of a parameter of this carrier, different from the respective stable states with which the other inputs are associated.

If said parameter is the phase, the inputs 426₁, . . . ,426₈ can, for example, each be associated with a carrier and respectively with phase states φ₁=0, φ₂=π/4, φ₃=π/2, φ₄=3π/4, φ₅=π, φ₆=−3π/4, φ₇=−π/2, φ₈=−π/4 of this carrier.

When an input among the inputs 426₁, . . . ,426₈ is selected, the carrier associated with this input is addressed to a radiofrequency stage 430, which transmits this carrier in the form of a signal that will be called a “transmission” signal.

The operation of the modulation stage 420 can be as follows: when a new data item Dₙ of a succession of data items D₀, . . . , Dₙ₋₁, Dₙ, . . . , Dₚ (with n and p being integers) to be modulated, from the asynchronous circuit 410, arrives at the state machine 422, the latter selects a new input Xₙ among the k=8 inputs 426₁, . . . ,426₈ of the multiplexer means 424, according to the value of the new data item Dₙ, and the input Xₙ₋₁ among the 8 inputs 426₁, . . . ,426₈, during selection or that had been selected for a previous modulation of another data item Dₙ₋₁, performed just before that of said new data item Dₙ.

The new input Xₙ selected is different from the other input Xₙ₋₁ during selection or that had been selected for the previous modulation of another data item Dₙ₋₁.

Once the new input Xₙ has been selected, the carrier associated with this new selected input Xₙ is addressed to the RF stage 430, which transmits this new carrier in the form of the “transmission” signal. The selection of said new input Xₙ, and the transmission of the new carrier associated with this new input, can be maintained insofar as no other data item following data item Dₙ in said succession of data items D₀, . . . ,Dₙ₋₁,Dₙ, . . . ,Dₚ arrives at the modulation stage.

Such a modulation device is capable of performing modulations according to an irregular periodicity, and according to a rate, depending on the rate of data transmitted by the asynchronous circuit 410, and independent of the frequency of a carrier or of the transmission signal. The modulations performed by this device can be performed without synchronization with a carrier and/or without correlation with a carrier. The data or information can also be transmitted at an irregular rate to the transponder 4, in modulated form via the “transmission” signal.

An example of a modulating signal 210, with two states, comprising a succession of information or data items transmitted at an irregular rate by the asynchronous circuit 410, is shown in FIG. 2A. The separation between the data items in the signal 210 or the arrival of a new data item in this signal 210 is indicated to the stage 420, by means of the synchronization signal 225 shown in FIG. 2B, accompanying the modulating signal 210 (the separation between the data items in this signal 210 being signified in this figure by non-continuous vertical lines).

An example of a phase-modulated transmission signal 230 transmitted by the RF stage 430 to the reader is shown in FIG. 2C.

Each new data item contained in the transmission signal 230 is identified by a transmission or a jump of a parameter of the transmission signal, from a first so-called “stable” position or a first so-called “stable” state, belonging to a set or to a cyclic list of stable positions or stable states that said parameter of the transmission signal is capable of adopting, to a second position or a second “stable” state of said cyclic list of stable states.

The value of a new data item is indicated or coded, in particular by the amplitude and/or the direction, of a transition or a jump, from a first stable position, among said stable positions of the list of stable positions that the parameter is capable of adopting, to a second stable position, among said stable positions that the parameter is capable of adopting, independently both of the stable “origin” position (among the list of stable positions) on the basis of which the jump is performed, and the stable “arrival” (among the same list of stable positions) and to which the jump leads or at which it ends.

In other words, the value of a new data item is indicated or coded by the amplitude and/or the direction of a transition or a jump from a first stable state of the list of stable states to a second stable state of the list of stable states, without it being necessary to identify which stable state this first stable state corresponds to or which stable state the second stable state corresponds to.

The parameter can be, for example, the phase of the transmission signal.

In this case, each new data item contained in the transmission signal is identified by a phase jump, from a first “stable” phase position, among a cyclic list of phase positions that the phase of the transmission signal is capable of adopting, to a second “stable” phase position, among said cyclic list.

The value of this new data item is indicated or coded by the amplitude of the phase jump and/or by the sign of this phase jump, without it being necessary to respectively identify which stable “phase” state the first stable phase state corresponds to and which stable “phase” state the second stable phase state corresponds to among the list of stable states.

As described above, in the modulation device, when a new data item Dₙ of a succession of data items D₀, . . . ,Dₙ₋₁,Dₙ, . . . ,Dₚ to be modulated arrives at the modulation stage 420, the state machine 422 performs, among the inputs 426_{1, . . . ,} 426_{8,} multiplexing means 424, a selection of a new input, different from the input “in progress” previously selected. This change in input causes a jump from a first state to a second state of a parameter of the transmission signal.

FIG. 3 shows an example of the implementation of such a modulation, in particular a phase modulation, in which the phase Φ of the modulated carrier signal or of the transmission signal is capable of adopting 8 positions or stable states denoted φ₁, φ₂, φ₃, φ₄, φ₅, φ₆, φ₇, φ₈, respectively corresponding, for example, to phase values equal to 0, π/4, π/2, 3π/4, π, −3π/4, −π/2, −π/4.

For this modulation example, the phase Φ of the transmission signal is capable of performing phase jumps in a positive or negative direction, with an amplitude equal to π/4.

Thus, in this example, phase jumps in the transmission signal with a value of +π/4 from any first of the 8 stable states noted φ₁, φ₂, φ₃, φ₄, φ₅, φ₆, φ₇, φ₈, to a second stable state among these 8 states, designate or code a first type of information or a first data value, while phase jumps in the transmission signal with a value −π/4 from any first of the 8 stable states φ₁, φ₂, φ₃, φ₄, φ₅, φ₆, φ₇, φ₈, to a second state designate or code a second type of information or a second data value.

In this figure, a first and a second phase jump, in a positive direction, and with an amplitude equal to π/4, as well as a third and a fourth phase jump, in a negative direction and with an amplitude equal to π/4, are represented, respectively, by arrows 350, 352, 360, 362.

The first phase jump 350 of value +π/4, is performed from the stable state 95 to the stable state φ₆, while the second phase jump (shown by an arrow referenced 352) on the order of +π/4 is performed from the stable state φ₆ to the stable state φ₇. These two jumps code a same first data value of the modulating signal.

The third phase jump (represented by an arrow referenced 360), of −π/4, is performed from the stable state φ₇ to the stable state φ₆, and the fourth jump (represented by an arrow referenced 362), also of −π/4, is performed from the stable state φ₆ to the stable state φ₅. These two jumps code a same second data value of the modulating signal.

In FIG. 2B, a signal 220 produced in the modulator stage 420 shows a succession of phase jumps of π/4 or −π/4, and passages from stable phase state to stable phase state of the transmission signal 230 shown in FIG. 2C, modulated by the modulating signal 210 shown in FIG. 2A, and in particular the first jump 350 (from position φ₅ to position φ₆), the second jump 352 (from position φ₆ to position φ₇), the third jump (from position φ₇ to position φ₆) the fourth jump 362 (from position φ₆ to position φ₅), mentioned above. The first jump 350 and the second jump 352, in signal 220, correspond respectively to a first data item 250 of the modulating signal 210 and a second data item 252 of the modulating signal 210, with the first data item and the second data item having a same first value, for example the value ‘1’, while the third jump 360 and the fourth jump 362 respectively correspond to a third data item 260, and to a fourth data item 262, wherein the third data item 260 and the fourth data item 262 have a same second value, for example the value ‘0’.

The modulation implemented according to the invention is not limited to values of positions or stable states equal to 0, π/4, π/2, 3π/4, π, −3π/4, −π/2, −π/4. The positions or stable states chosen can be, according to another example, equal to π/8, 3π/8, 5π/8, 7π/8, −7π/8, −5π/8, −3π/8, −π/8. The modulation implemented according to the invention is also not limited to phase jumps equal to π/4.

An initialization step in which the reader sends a transmission signal, in particular free of data, indicating to the transponder, an initial reference state of the modulation parameter, on the basis of which the jumps will be performed, can be implemented. This reference state can be unknown to the demodulation device before exchanges between the reader and the transponder begin or before any exchange between the reader and the transponder begins.

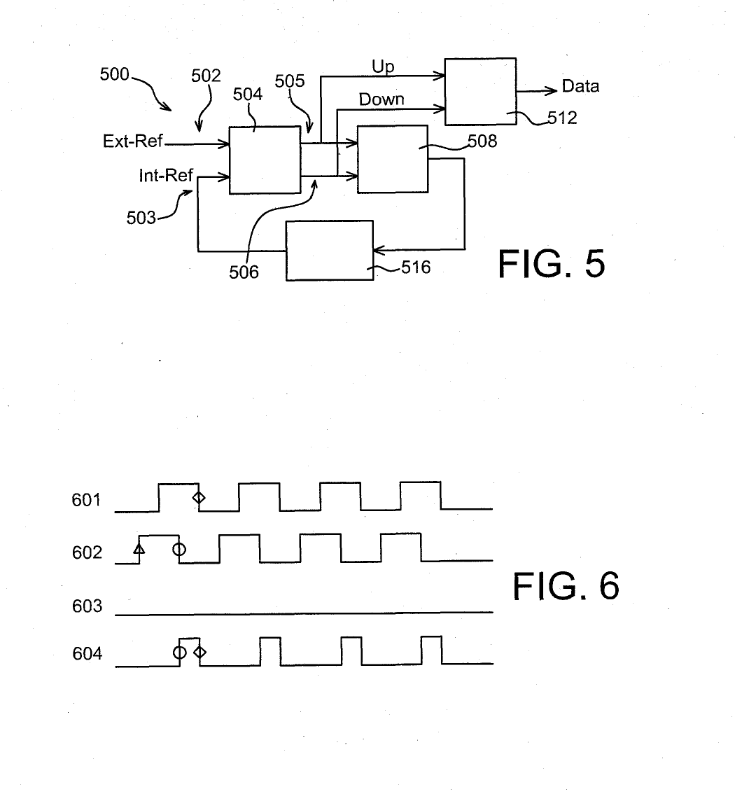

An example of a demodulation device according to the invention, included in the transponder 4, capable of demodulating a transmission signal such as 230, will now be described in relation to FIG. 5.

This device first includes a stage (not shown) for receiving signals coming from the reader 2, equipped with at least one antenna, an LC circuit, possibly associated with means for forming (not shown) the transmission signal 230. These forming means can be equipped with a voltage limiting circuit, making it possible to produce, on the basis of the “transmission” signal 230, a signal comprising the same phase variations, but with a substantially constant amplitude, for example below 3 volts, and possibly for discharging an excess of energy from this signal 230.

The “transmission” signal, or the phase-modulated carrier signal, at the output of the receiving stage, is denoted Ext-Ref and transmitted to a stage including a phase-locked loop 500 (PLL) of the demodulation device.

Prior to any demodulation of information contained in the carrier signal, this loop 500 performs a lock to the “transmission” signal. By this locking, a reference signal inside the demodulator denoted Int-Ref is formed.

After the locking, an initial stable phase state, in which the Ext-Ref signal and the reference Int-Ref signal are in phase, can be detected.

The Int-Ref signal is controlled by the phase of the transmission signal or is dependent on the value of a phase state preceding the Ext-Ref signal.

No clock generation or regeneration stage, or clock division stage, capable of indicating to the transponder a rate of arrival of the data contained in the transmission signal, is provided. The demodulation device does not perform any sampling or processing according to an information arrival frequency that is predetermined, or determined by means of synchronization data contained in the Ext-Ref signal.

After locking, detections of information to be demodulated can be performed by detecting phase jumps on the carrier or “transmission” signal, from stable phase states to stable phase states. These phase jumps can arrive at an irregular rate at the demodulation device.

The Ext-Ref signal, also called an external reference signal and recovered by the loop 500, is compared with the Int-Ref signal, which serves as an internal reference signal and which comes from a voltage-controlled oscillator (VCO) 516.

This comparison can be performed by phase and frequency detection means 504. These phase and frequency detection means 504 detect the phase differences between the Ext-Ref signal and the internal reference signal Int-Ref by comparison of the levels of these two signals.

The phase and frequency detection means 504 detect, for example, the rising and falling edges on each of their inputs 502 and 503 so as to determine which of these inputs 502 or 503 is in front. A comparison of the Ext-Ref and Int-Ref signals makes it possible to generate a peak of which the width corresponds to the phase deviation between the two inputs 502 and 503. If this deviation is a phase advance of Ext-Ref with respect to Int-Ref, an output 505 of means 504 can be activated and a signal of a type denoted ‘UP’ can be generated on this output 505. Otherwise, if the deviation is a phase delay of Ext-Ref with respect to Int-Ref, another output 506 of the means 504 can be activated and a signal of a type denoted ‘DOWN’ can be generated on this other output 506.

A process of detecting phase deviations is shown in FIG. 6, in a case in which the internal reference signal, denoted 602 in this figure, is in phase advance with respect to the external reference signal, denoted 601. The output 505 of the means 504 is deactivated (signal 603), while on the other output 506, which is activated, a ‘DOWN’-type signal (curve 604) appears, with a width equal to the phase deviation between the two Ext-Ref and Int-Ref signals, and indicating, for example, a negative phase jump.

The result of the comparison is transmitted in particular to charge pumping means 508, which make it possible, according to this result, to modulate the control voltage of the voltage-controlled oscillator 516. The internal reference signal Int-Ref thus forms a memory of the Ext-Ref signal.

A phase jump, from a first state or a first position, to a second state or a second position, leads to a rupture of a stability state of the PLL on the modulated carrier signal and is detected by asynchronous phase jump detection means 512, at the output of the phase and frequency detection means 504.

A continuous control of the phase deviations between the transmission signal and the internal reference signal is implemented. The system forms means for monitoring or for continuous detection of the arrival of new information.

The asynchronous means for detection of phase jumps 512 are capable of demodulating the event-related data rate, without a clock, and in particular without a reference clock of the information rate, and/or without performing a correlation with the “transmission” signal.

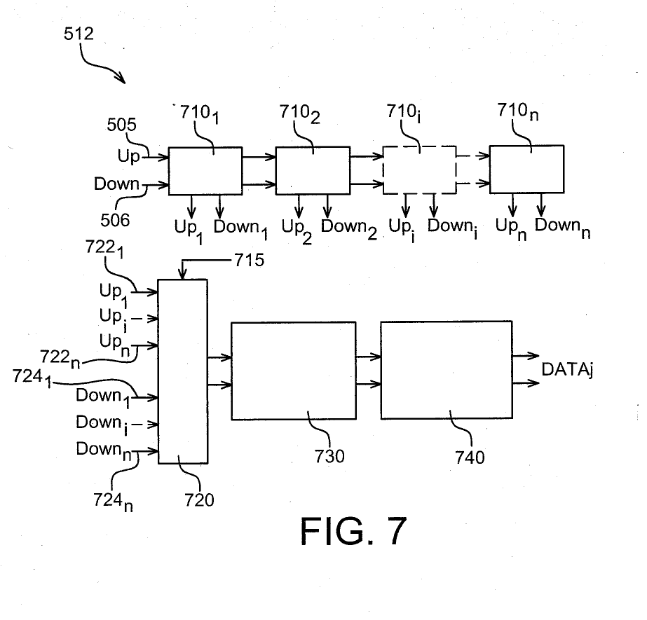

According to an example of an implementation of the phase detection means 512, shown in FIG. 7, these means 512 can include n (with n being an integer greater than 2) filtering cells 710₁, . . . , 710ₙ, respectively associated, for example, with a type of filtering or with a filtering amplitude and making it possible to more or less substantially filter a succession of ‘UP’- and/or ‘DOWN’-type signals, for example by reducing the width of the peaks corresponding to the jumps. The asynchronous phase detection means 512 also comprise multiplexing means 730, of which the inputs 722₁, . . . ,722ₙ and 724₁, . . . ,724ₙ, are connected to the cells 710₁, . . . , 710ₙ. According to an order imposed by the cells 710₁, . . . , 710ₙ, the multiplexing means 720 are capable of transmitting, to so-called “envelope detection” means 730, the ‘UP’- and/or ‘DOWN’-type signals.

Such a filtering 710ᵢ among the cells 710₁, . . . , 710ₙ is selected (input 715 validated) according to the position of the transponder in the field of the reader.

A phase jump filtering implemented by means 710ᵢ to 710ₙ makes it possible to dissociate variations of the phase parameter or a phase jump indicating the arrival of a new data item, from phase jumps due to noise.

For this, one or more detection thresholds may have been determined. These filtering means can implement a detection of the duration of jumps, for example by detecting the width of ‘UP’- or ‘DOWN’-type signals, wherein a jump duration below a given threshold can, for example, be considered to be noise.

Phase jumps ΔΦ below π/4 or −π/4, can thus be, for example, filtered by these means 512, and considered to be due to noise.

Phase jumps ΔΦ with an amplitude on the order of π/4 or −π/4, will be considered to be new information to be demodulated. This data, once filtered, is processed by a digital module, belonging to the envelope detection means 730, and which carries out a vote to determine the value or the code of the information received.

The amplitude of variation of the feedback control parameter, in this example, the amplitude of the phase jump, and the sign of variation of the feedback control parameter, in this example the sign of the phase jump, are placed in correspondence with at least one data item in the form, for example, of a bit, or a set of bits, for example using a correspondence table stored in the digital module.

This correspondence is achieved according to the direction of the phase jump indicated, for example, by an ‘UP’-type signal for a positive jump, and by a ‘DOWN’-type signal for a negative jump, and the amplitude of the phase jump, without these means 730 having knowledge of the starting value of the jump, or of the initial state of the phase of the Ext-ref signal prior to this jump.

A phase jump of +π/4 can be associated with this module, for example at a data item of value ‘1’, whereas a phase jump of −π/4 can be associated, for example, with a data item of value ‘0’.

The valid data is sent to coding means 740 until a new stable state is detected. When a new stable state is detected, the means for detecting the envelope 730 and means 740 are then reinitialized.

Then, the coding means 740 make this data compatible, i.e. coded, for example by means of a multi-rail coding for an asynchronous digital circuit downstream of the demodulator, which can be of the type that is “almost insensitive to the delays”, for example an asynchronous microcontroller as described in document [1] (referenced above).

After a phase jump due to the presence of new information to be demodulated, the multiplexing means 720 transmit to the means 730 a new ‘UP’- or ‘DOWN’-type signal, and the feedback system is stabilized toward another stable phase state.

A handshake protocol can be implemented between the transponder and the reader. According to this protocol, after having demodulated a data item or a succession of data items, the transponder may transmit a signal of acknowledgement of this data item or of this succession of data items, before demodulating a new data item or a new succession of data items. The acknowledgement signal can be generated by means 512.

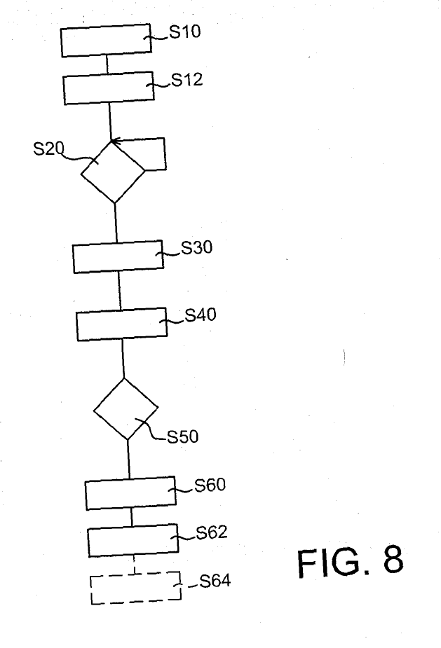

FIG. 8 shows a method for processing a transmission or modulated carrier signal denoted Ext-Ref, implemented by the demodulation device described above.

Prior to any demodulation of information contained in the Ext-Ref signal, an initialization phase is provided. This phase includes a step S10, of locking to the “transmission” signal performed by the loop 500, in which the Int-Ref signal controlled by the phase of the modulated carrier signal is formed.

This step is accompanied by a detection or associated with a detection (step S12) of a first stable state of the phase of the “transmission” signal. On initialization, this first “stable phase state” becomes the stable phase state “in progress”.

After initialization, a continuous monitoring (step S20) for the presence of information to be demodulated is implemented, by detecting phase jumps (step S30) of the “transmission” signal. Thus, a detection of a rupture of a position of stability during the phase of the Ext-Ref transmission signal is performed.

A noise-filtering step is then implemented (step S40).

If a phase jump from the stability state in progress to a second state is detected, a comparison of the amplitude of the jump and/or of the direction of the jump at one or two detection thresholds is performed (step S50).

The continuous detection process can then start again (return to step S20).

The amplitude of the jump and or the direction of the jump is associated (step S60) with a value, in the form of a bit or a set of bits, independent of the first stable state.

A detection of a stabilization in the second state, prior to another detection, is then performed. The second state then becomes the “stable state in progress” (step S62).

According to an alternative implementation, a demodulation acknowledgement signal can be sent (step S64) to the reader 2 after step S62 and before the continuous detection process is restarted.

1-10. (canceled)

11. A method for asynchronous exchange of information by inductive coupling or without contact between a reader and a transponder, comprising:
a plurality of demodulation operations, by the transponder, of a transmission signal coming from the reader, each demodulation operation including:
a) detecting a transmission signal parameter jump, from a first state to a second state, among a set of stable states that the parameter of the transmission signal is capable of adopting, by comparing the transmission signal with a reference signal,
b) comparing an amplitude of the jump and/or a direction of the jump, with one or more predetermined threshold values,
c) associating the amplitude of the jump and/or the direction of the jump, with a value, independent of the first state, and
d) detecting a stabilization at the second state, prior to another demodulation operation; and
a plurality of modulation operations, by the reader, of a modulating signal using at least one carrier signal, wherein the modulation operations are mutually asynchronous and asynchronous with the carrier signal.

12. A method for asynchronous exchange of information by inductive coupling or without contact between a reader and a transponder according to claim 11, the reference signal being dependent on the value of the parameter at the first state and the value of the parameter of the transmission signal.

13. A method for exchange of information by inductive coupling or without contact between a reader and a transponder according to claim 11, each demodulation operation further including, after the associating c) and before another demodulation operation: sending, to the reader, a demodulation acknowledgement signal.

14. A method for asynchronous exchange of information by inductive coupling or without contact between a reader and a transponder according to claim 13, a selection being made, prior to the modulation operations, of at least one carrier and an initial state of a parameter of the carrier among a plurality of states that the parameter of the carrier is capable of adopting, wherein the modulation operations include:
detecting at least one new data item to be modulated, and
selecting a new state, among a plurality of states that the parameter of the carrier is capable of adopting, according to a previously selected state, and of the value of the new data item.

15. A method for exchange of information by inductive coupling or without contact between a reader and a transponder according to claim 11, the parameter being the phase of the transmission signal.

16. A transponder device, comprising:
means for receiving a transmission signal formed on the basis of at least one carrier signal, coming from a reader;
means for implementing a plurality of demodulation operations of the transmission signal, wherein the demodulation operations are mutually asynchronous and asynchronous with a modulated carrier signal, and, each demodulation operation includes:
detecting a transmission signal parameter jump from a first state to a second state by comparing the transmission signal with a reference signal,
comparing an amplitude of the jump and/or a direction of the jump, with one or more predetermined threshold values,
associating the amplitude of the jump and/or the direction of the jump, with a value, independent of the first stable state, and
detecting a stabilization at the second state, prior to another demodulation; and
means for sending, after a demodulation operation and prior to another demodulation operation, a demodulation acknowledgement signal.

17. A transponder device according to claim 16, the reference signal being dependent on the value of the parameter at the first state and the value of the parameter of the transmission signal.

18. A transponder device according to claim 17, the parameter being the phase of the transmission signal.

19. A device for reading by inductive coupling or without contact, comprising:
means for forming a transmission signal, based on at last one carrier signal;
means for transmitting the transmission signal to a transponder; and
means for implementing a plurality of modulation operations of the transmission signal, by a modulating signal, wherein the modulation operations are mutually asynchronous and asynchronous with the carrier signal.

20. A device for reading by inductive coupling or without contact according to claim 19, the means for implementing a plurality of transmission signal modulation operations also including means for acquisition of a modulating signal including a plurality of data to be modulated, wherein the means for implementing a plurality of modulation operations also includes:
means for selecting, prior to the modulation operations, an initial state of a parameter of the carrier signal among a plurality of states that the parameter of the carrier signal is capable of adopting, and for selecting, at each of the modulation operations, a new state of the parameter of the carrier, according to a previously selected state and the modulating signal.
